(19) United States
(12) Patent Application Publication
(10) Pub. No.: US 2014/0122407 A1
(43) Pub. Date: May 1, 2014

(54) CHATBOT SYSTEM AND METHOD HAVING AUTO-SELECT INPUT MESSAGE WITH QUALITY RESPONSE

(71) Applicant: Xiaojiang Duan, Chaoyang District (CN)

(72) Inventor: Xiaojiang Duan, Chaoyang District (CN)

(21) Appl. No.: 13/661,046

(22) Filed: Oct. 26, 2012

(51) Int. Cl. G06N 5/02

(52) U.S. Cl. 706/50

(57) ABSTRACT

A candidate message chatbot system and method. The chatbot includes an interactive dialog interface for engaging in a chat session with a user. The user can enter one or more characters as an input message during the chat session. The chatbot can match the one or more characters with a plurality of candidate messages in a knowledge database, the plurality of candidate input messages being part of input/output knowledge entry or known to generate at least a quality response.

### CROSS-REFERENCE TO RELATED APPLICATIONS

This application is related to the following U.S. non-provisional patent applications: U.S. patent application Ser. No. ______, entitled “User-Aided Learning Chatbot System and Method” filed herewith (Attorney Docket No. ACOSYS.002US); U.S. patent application Ser. No. ______, entitled “Chatbot System and Method with Contextual Input and Output Messages” filed herewith (Attorney Docket No. ACOSYS.003US); U.S. patent application Ser. No. ______, entitled “Chatbot System and Method with Enhanced User Communication” filed herewith (Attorney Docket No. ACOSYS.004US); U.S. patent application Ser. No. ______, entitled “Chabot System and Method with Interactive Chat Log” filed herewith (Attorney Docket No. ACOSYS.005US); all of which are hereby incorporated by reference in their entirety as if fully set forth in the present invention for all purposes.

### COMPUTER PROGRAM LISTING APPENDIX

A computer program listing appendix is provided via EFS with this application. The information is hereby incorporated by reference as if set forth in full in this application for all purposes. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text; otherwise all copyright rights are reserved.

### BACKGROUND OF THE INVENTION

The present invention relates generally to chatbot systems and methods and more specifically to candidate message chatbot systems and methods.

Chatbots are designed to simulate an intelligent conversation with one or more human users via auditory or textual methods. Chatbots often include a knowledge base and a set of algorithms enabling users to submit input messages to the chatbot. The knowledge base entries attempt to match the user input message with corresponding patterns for chatbot response.

An interactive dialog, known as a chat session, often occurs when a user submits a first input message to a chatbot. Upon receipt, the chatbot matches the input message with an input pattern in its knowledge base having a corresponding output response. Thereafter, the chatbot generates and displays the output response to the user.

The user might then follow up by submitting a second input message. In this case, the second input message might have different words but the same meaning as a knowledge entry pattern that is present in the knowledge base. Upon receipt of the second input message, the chatbot attempts to match the second input message with the knowledge entry pattern that is present in the knowledge base.

After searching (or attempting to match the second input message), the chatbot either generates no response or fails to provide an intelligible response, even though the required knowledge entry pattern and reply are present in the knowledge base. The chatbot fails to respond as it cannot interpret that the second input message and the knowledge entry pattern have the same meaning.

It is within the above context that a need for the present invention has arisen. There is, thus, a need to address one or more of the foregoing disadvantages of conventional systems and methods, and the present invention meets this need.

### BRIEF SUMMARY OF THE INVENTION

Various aspects of a candidate messages chatbot system and method can be found in exemplary embodiments of the present invention.

In a first embodiment, the candidate messages chatbot system and method matches one or more characters of a user input message with a plurality of candidate input messages in a knowledge database. The candidate input messages are known to be paired with or can provide quality output messages from the knowledge database. The user selects the displayed candidate message to receive the output response from the chatbot.

1111 The method begins by initiating a chat session when one or more characters of an input message are received from a user via an interactive dialog interface that is responsive to the input message. The input message includes one or more characters. The chatbot then receives the input message having the one or more characters.

Responsive thereof, the chatbot matches the one or more characters of the input message with the plurality of candidate input messages in the knowledge database. The matching is such that only candidate input messages that have corresponding output responses in the knowledge database are matched.

Conversely, candidate input messages in the knowledge database that do not have corresponding output responses are not matched. In this manner, and unlike conventional systems, when a user submits an input message that is different in structure but has the same meaning a knowledge base entry, an embodiment of the present invention generates at least a quality response and an intelligible response so long as one of the candidate input messages is selected.

By selecting a candidate input message, the user does not enter the user's own message and thus cannot enter a message having a different structure but with the same meaning as a knowledge base entry. The user is adopting the candidate input message and the corresponding entry associated with the candidate input message.

A further understanding of the nature and advantages of the present invention herein may be realized by reference to the remaining portions of the specifications and the attached drawings. Further features and advantages of the present invention as well as the structure and operation of various embodiments of the present invention are described in detail below with respect to the accompanying drawings. In the drawings, the same reference numbers indicate identical or functionally similar elements.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a chatbot communication system according to an exemplary embodiment of the present invention;

FIG. 2 illustrates a chatbot dialog interface of the chatbot system of FIG. 1 in accordance with an exemplary embodiment of the present invention;

FIG. 3 illustrates the chatbot dialog interface of FIG. 2 in accordance with an embodiment of the present invention;

FIG. 4A illustrates the chatbot dialog interface 216 of FIG. 2 and a corresponding knowledge table according to an exemplary embodiment of the present invention;

FIG. 4B illustrates a chatbot dialog interface according to an exemplary embodiment of the present invention;

FIG. 5 illustrates a candidate message chatbot method in accordance with an embodiment of the present invention;

FIG. 6A illustrates a typical computer such as would be employed for operation of the present invention and/or operated by a user on the Internet, and

FIG. 6B illustrates subsystems of the computer of FIG. 6A.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail so as to not unnecessarily obscure aspects of the present invention.

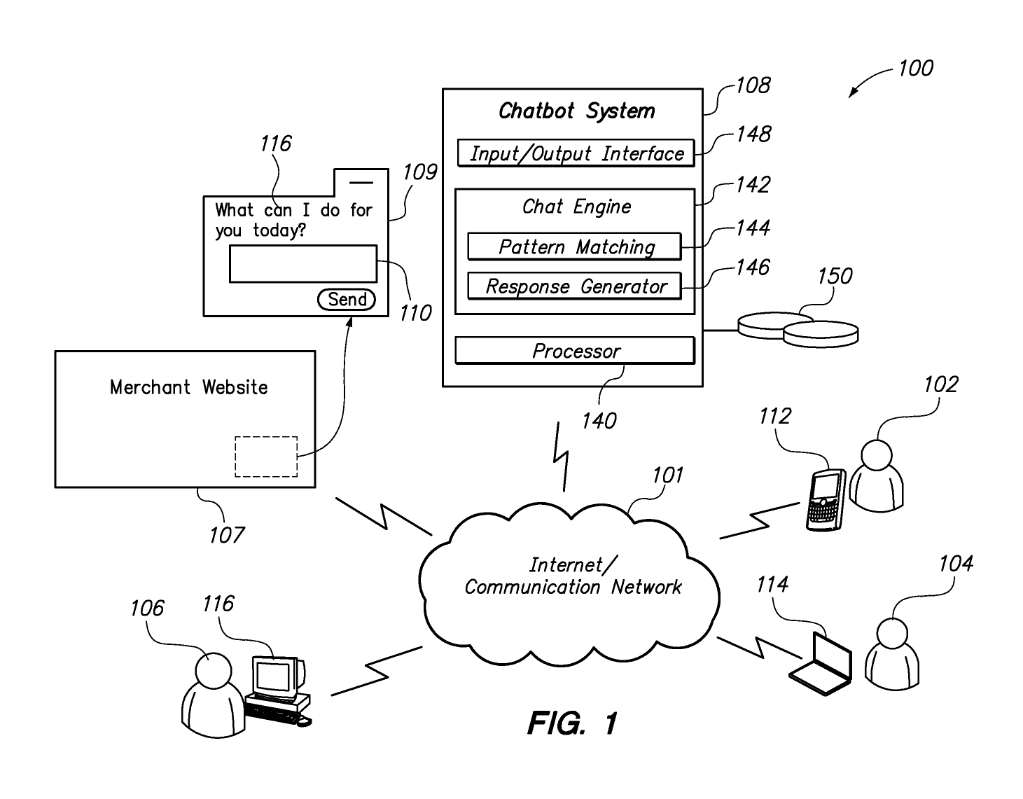

FIG. 1 illustrates chatbot communication system 100 according to an exemplary embodiment of the present invention.

In FIG. 1, chatbot communication system 100 comprises user 102 communicably coupled to chatbot system 108 via Internet 101. User 102 represents a customer visiting a website over Internet 101, and commencing a chat session with chatbot system 108.

Internet 101 represents any distributed network (wired, wireless or otherwise) for data transmission and receipt between/among two or more points. In some embodiments, chatbot system 108 includes a graphical image, including, without limitation, an avatar, a talking head, a text-to-speech engine, etc. Although not shown, chatbot system 108 might be installed on a stand-alone computer without need for a computer network.

As shown in FIG. 1, user 102 utilizes mobile device 112 to communicate with chatbot system 108. Mobile device 112 is a portable communication device such as a smart phone and the like. In one embodiment, the communication with chatbot system 108 can occur when user 102 is visiting one or more websites such as merchant website 107 that has chatbot dialog interface 116 of chatbot system 108 preinstalled on the website as further discussed below. User 102 essentially uses a browser (not shown) and chatbot dialog interface 116 to interact with chatbot system 108.

In FIG. 1, user 104 represents an additional customer. Many customers can concurrently communicate with chatbot system 108. Here, user 104 utilizes laptop computing device 114 for communicating with chatbot system 108 in a manner akin to user 102. For example, user 104 visiting merchant website 107 can also communicate with chatbot system 108 via chatbot dialog interface 116.

In FIG. 1, merchant 106 represents a merchant that operates merchant website 107. Merchant 106 installs chatbot dialog interface 116 of chatbot system 108 on its merchant website 107. Chatbot dialog interface 116 is a client extension of chatbot system 108. Thus, users can communicate with chatbot system 108 via chatbot dialog interface 116. Consequently, users visiting merchant website 107 can learn about products and/or services offered by merchant 106 by communicating with chatbot system 108 via chatbot dialog interface 116.

Here, merchant 106 provides initial training for chatbot system 108 by using a browser (not shown) on desktop computing device 115. Specifically, merchant 106 uses the browser to access and display chatbot dialog interface 116 to communicate with chatbot system 108. In essence, merchant 106 provides the message and theme for chatbot system 108 while users 102, 104 are the corresponding consumers.

Merchant 106 can train chatbot system 108 by entering input messages into dialog box 110 of chatbot dialog interface 116. Chatbot system 108 responds to an input message by displaying an output message via output display 109 above dialog box 110. As shown, an output message “What can I do for you today?” is displayed by output display 109. Note that this is a special output message, called an initial or opening message. Its corresponding “input message” is the user's action of browsing to a web page.

Chatbot messages are generated by chatbot system 108 by querying the input message from users in a knowledge base according to a certain set of rules. Merchant 106 trains chatbot system 108 to provide modified messages for a chat session by replacing chatbot system 108's initial chatbot messages with user-generated messages.

Chatbot system 108 includes a graphical image representing chatbot dialog interface 116, the graphical image including, without limitation, an avatar, a talking head, a text-to-speech engine, etc. In some embodiments, users 102, 104, 106 enter input messages to chatbot system 108 with a keyboard, mouse, and a visual recognition device.

The back and forth interaction between chatbot system 108 and users 102, 104 and 106 via chatbot dialog interface 116 allows knowledge database 150 to store and process myriad combinations of user-generated messages as context for additional future chatbot messages.

In FIG. 1, chatbot system 108 includes input/output interface 148 for entering and displaying messages to and from users 102, 104, 106. Chatbot system 108 also includes chat engine 142 that receives an input message from dialog box 110 and processes the input message by pairing or associating the input message with an appropriate chatbot message. Note that, conveniently, one or more components of chatbot system 108 may be conveniently referred to as chatbot system 108.

Chat engine 142 utilizes pattern matching engine 144 to recognize appropriate responses for input messages. In one embodiment, pattern matching engine 144 employs AIML (Artificial Intelligence Markup Language), which is an XML dialect. Note that AIML implementation is used in one embodiment but other implementations are used as well. Here, AIML comprises several elements. A first is category, which is a fundamental unit of knowledge. A category includes two or more elements (e.g. pattern and template).

<category>

<pattern>WHAT IS YOUR NAME</pattern>
<template>My name is Eddy.</template>

</category>

When this category is loaded, a chatbot receiving an input “What is your name” can respond with “My name is Eddy.” Here, a pattern is a string of characters that can match one or more user inputs. A pattern such as “What is your name” matches only one input, whether upper or lower case. However, patterns can also contain wildcards; thus, “what is your *” can match many inputs such as “what is your objective,” what is your address,” etc.

A template provides the response for a pattern. An example of a template is—My name is Eddy. A template can also use variables. A template may be as simple as some literal text, like “My name is <chatbot name=“name”/>,” which substitutes the chatbot's name into the sentence, or “You said you are <get name=“userage”/> years of age,” in which the user's age is replaced in the sentence.

Text formatting, conditional response (if then/else), and random responses are elements of templates. Templates can also use the srai element to redirect to another pattern.

<category>

<pattern>What is your name</pattern>
<template>My name is <bot name=“name”></template>

</category>
<category>

<pattern>WHAT IS YOUR GIVEN NAME</pattern>

<template>

<srai>What is your name</srai>

</template>

</category>

In the first category, the input “What is your name” receives the chatbot's name as a response. In the second category, the input “WHAT IS YOUR GIVEN NAME” is redirected to the category that matches the input “What is your name.” In essence, the two phrases are equivalent. Templates may include other content types that are processed by the chatbot user interface. As an example, a template may employ HTML (Hyper-Text Markup Language) tags for formatting. Clients not supporting HTML typically ignore the tag.

Those skilled in the art will recognize that other techniques that can either substitute or supplement pattern matching engine 144 can be employed. After pattern matching engine 144 recognizes appropriate responses for input messages, pattern matching engine 144 then passes the chatbot message to response generator 146, which generates an appropriate response.

In FIG. 1, in one embodiment, knowledge database 150 may receive and store input messages 210 and user-generated messages including the context for such messages, the messages being received via chatbot dialog interfaces 116 displayed on mobile device 112, laptop computing device 114 or desktop computing device 115. Many components of chatbot system 108 have been omitted to avoid unnecessarily complicating the description of the invention. One skilled in the art will realize that chatbot system 108 may comprise more or less components as needed to implement the present invention.

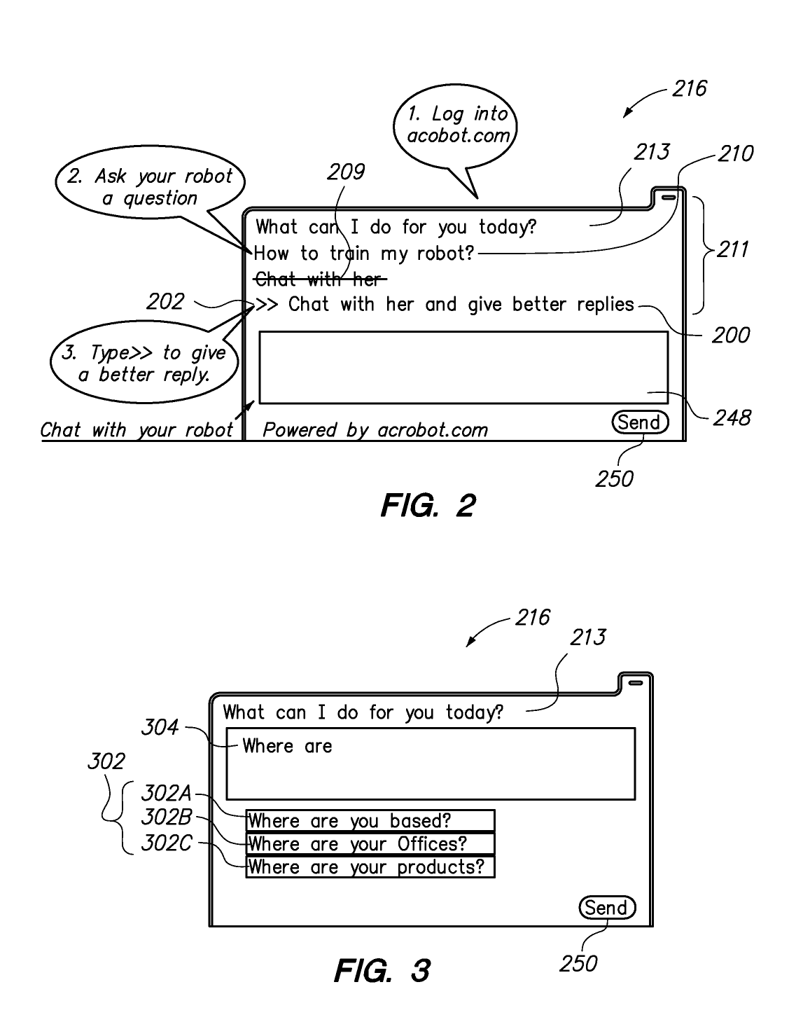

User-generated messages provide a context for subsequent chatbot messages of chatbot system 108, and for subsequent user input messages. In this manner, a new chatbot message is repetitively modified both prior to and during a chat session by entering a plurality of user-generated messages and training chatbot system 108 by preceding and/or following user-generated messages with unique identifiers (e.g., 202 of FIG. 2).

Briefly, in operation, merchant 106 trains chatbot system 108 to provide modified chatbot messages that are displayed by output display 109 of chatbot dialog interface 116. Merchant 106 utilizes merchant website 107 to install and utilize chatbot system 108. Merchant website 107 can provide a plethora of information to numerous customers simultaneously. Merchant website 107 operatively couples to Internet 101 via local network line 128.

Merchant 106 trains chatbot system 108 to provide modified chatbot messages 109 during a chat session. Thus, for example, merchant 106 might wish to teach chatbot system 108 to respond to address inquiries received from users of merchant website 107. User/merchant 106 begins by entering “Where are your offices?” into chatbot dialog interface 116.

In response, chatbot system 108 might generate a response such as “Please check our website, thank you.” Merchant 106 being dissatisfied with this message may wish to replace this chatbot response with the merchant's business address. Generally, merchant 106 can then enter “100 Main Street” into chatbot dialog interface 116. Thereafter, when the customer enters an input message “Where is your business located?,” chatbot system 108 replies, “100 Main Street”. Those skilled in the art will recognize that user-generated message (provided by merchant 106) is more robust and descriptive than the initial chatbot message.

FIG. 2 illustrates chatbot dialog interface 216 of chatbot system 108 (FIG. 1) in accordance with an exemplary embodiment of the present invention.

In FIG. 2, chatbot dialog interface 216 includes a visual graphic that encompasses two main areas namely dialog box 248 and output display 211. User input messages entered via dialog box 248 are displayed in output display 211. Chatbot response messages generated by chatbot system 108 are also displayed by output display 211.

Once chatbot system 108 is initialized, chatbot dialog interface 216 is displayed and is ready to initiate a chat session. Specifically, upon initiation, chatbot system 108 displays a prompt message “What can I do for you today?” 213 that prompts merchant 106 for an input message. “What can I do for you today?” 213 is a special output message, called an initial or opening message.

Responsive to prompt message “What can I do for you today?” 213, the user (e.g. merchant 106) enters an input message “How to train my robot?” 210 into dialog box 248 and then clicks send button 250. Chatbot system 108 responds by displaying output message “Chat with her” 209. Here, merchant 106 is dissatisfied with this message and wishes to train chatbot system 108 to display a modified message from the user.

Merchant 106 then enters user-generated message “Chat with her and give better replies” 200 into dialog box 248. This user-generated message 200 is preceded by a predetermined unique identifier such as the double angle brackets “>>” 202. Alternatively or in addition, the user-generated message 200 may be followed by the predetermined unique identifier. Those skilled in the art will realize that other identifier types e.g., asterisk, etc. can by utilized consistent with the spirit and scope of the present invention.

Predetermined unique identifier 202 directs chatbot system 108 to replace output message “Chat with her” 209 with user-generated message “Chat with her and give better replies” 200. As directed, chatbot system 108 responds to the predetermined unique identifier 202 and replaces output message “Chat with her” 209 with user-generated message “Chat with her and give better replies” 200 and then displays a crossed-out output message “Chat with her” 209 in output display 211 to indicate that message 209 is no longer valid.

Future input inquiries relating to “How to train my robot?” entered into dialog box 248 would generate the response “Chat with her and give better replies”. In this manner, merchant 106 can train chatbot system 108 to provide enhanced responses to input messages from user 102 or other customers. The back and forth interaction between chatbot system 108 and merchant 106 via chatbot dialog interface 216 allows knowledge database 150 (FIG. 1) to be modified based on myriad combinations of user-generated messages 200 as context for additional future chatbot messages.

FIG. 3 illustrates chatbot dialog interface 216 of FIG. 2 in accordance with an embodiment of the present invention.

In FIG. 3, as shown, chatbot dialog interface 216 is displaying one or more characters 304 entered by a user and responsive to the one or more characters 304 a plurality of candidate input messages 302 is displayed for user selection.

Specifically, user 102 (FIG. 1) enters one or more characters 304 to begin forming input message 210 (FIG. 2) to which a response from chatbot system 108 is desired. In one embodiment, chatbot system 108 (FIG. 1) receives and reacts to each one or more characters 304, processing and generating the plurality of candidate input messages 302, as one or more characters 304 increase or decrease. Chatbot system 108 repetitively matches the additional one or more characters 304 with plurality of candidate input messages 302 to retrieve additional candidate input messages 302.

As shown in FIG. 3, user 102 begins the chat session by entering the characters “Where are”. Those skilled in the art will recognize that this particular combination of characters is a common term used by users 102, 104 to make inquiries for directions to the location of a business (e.g., merchant 106). Chatbot system 108 recognizes the one or more characters 304 as a partial input message 210 and attempts to match the one or more characters 304 with one of the plurality of candidate input messages 302 from knowledge database 150.

Chatbot system 108 matches one or more characters 304 of input message 210 with the plurality of candidate input messages 302 in knowledge database 150 provided the plurality of candidate input messages 302 have corresponding responses or can provide at least a quality response. User 102 can thereafter select the desired candidate input message 302.

In FIG. 3, as shown, the plurality of candidates 302 displayed in response to one or more characters 304 are: “Where are you based” 302A; “Where are your offices” 302B and “Where are your products? 302C. In this manner, user 102 can adopt one of candidate input messages 302 as an input message for which a quality response is guaranteed for display to user 102.

In one embodiment of the present invention, no more than the plurality of candidate input messages 302 which also have corresponding output responses in knowledge database 150 is matched with one or more characters 304 of input message 210.

As previously noted, in conventional systems, a user entering an input message can receive either an unintelligible response or no response from the chatbot even though the knowledge base contains the necessary reply. This result occurs when the input message is different in structure or words but expresses the same meaning as a knowledge base entry pattern.

Unlike such conventional systems, so long as the user adopts one of the plurality of candidate input messages presented, at least a quality response from the knowledge database is guaranteed. Conversely, candidate input messages 302 that do not have corresponding output responses in knowledge database 150 are not matched with one or more characters 304 of input message 210.

As an example, assume that user 102 intends to submit an input message “where do you live?” Assume also that chatbot system 108 knowledge base includes a knowledge entry pattern “where do you reside?” and its output response “in Sunnyvale, Calif.” Here, the input message “where do you live currently?” and “where do you reside now?” have different words but have the same meaning.

In a traditional system, the user would submit the message “where do you live currently?” but the chatbot would produce no response as the chatbot cannot match the input message “where do you live currently?” with the input pattern “where do you reside now?” because they have different patterns. Unlike conventional systems, an embodiment of the present invention generates the response “in Sunnyvale, Calif.” since the candidate input message “where do you reside now?” is presented and selected before the user has an opportunity to complete the intended entry “where do you live currently?”

In FIG. 3, the plurality of candidate input messages 302 appear in order from top to bottom. In one embodiment, matching patterns starting with the text typed by user 102 are detected and the first three to five patterns are displayed as the plurality of candidates 302.

In one alternative embodiment, the pattern matching 144 (FIG. 1) may identify a wildcard in knowledge database 150. The wildcard may indicate that various permutations of the characters or text in the knowledge database are excluded from matching and retrieving for the plurality of candidate input messages 302. For example, without limitation, an asterisk indicates that characters to the right of an asterisk are not processed for matching.

In yet another alternative embodiment, chatbot system 108 returns patterns that contain one or more characters 304 anywhere within the input message, rather than one or more characters 304 that initiate input message 210. In yet another alternative embodiment, chatbot system 108 may utilize a general full-text search method and/or frame, including, without limitation, Lucene to query for the plurality of candidate input messages 302. In this manner, candidate input messages 302 that do not contain a pattern for matching with the one or more characters 304 are not displayed.

A further advantage of an embodiment of the present invention is that during the chat session, user 102 is provided with terms and phrases not previously considered by the user, those terms or phrases having the same structure or wording and meaning as corresponding input messages stored in knowledge database 150.

For example, without limitation, user 102 may input one or more characters 304 “How do”, with the intention of inquiring, “How do I purchase the product?” Chatbot system 108 matches the characters “How do” with input message patterns in its knowledge database, the input message patterns having corresponding responses. The specific matching process can vary depending on the algorithm used by chatbot system 108 or might be based on the preference of one skilled in the art.

In one embodiment, the input message patterns in knowledge database 150 are matched with one or more characters 304 “How do”. Chatbot system 108 may then provide a plurality of candidate input messages 302 that match or correlate to one or more characters 304 in input message 210. Candidate messages 302 may include, without limitation, “How do I install the product”, “How do I contact customer service”, and “How does the product work” which also have corresponding output responses in knowledge base 150 or that have quality responses that can be generated by chatbot system 108.

Those skilled in the art, in light of the present teachings will recognize that most users 102 that initiate the chat session have limited knowledge regarding the product or service discussed during the chat session. A plurality of candidate input messages 302 generated by chatbot system 108 may be sufficiently eclectic to provide insight to various inquiries that user 102 may not have considered.

Character matching: When user 102 enters a first character, chatbot system 108 returns words starting with the first character, the returned word being referred to as the first predicated word. When user 102 enters a second character, chatbot system 108 determines whether the character is a terminating character such as a space or exclamation mark, for example. If yes, chatbot system 108 returns the exact word having the first and the second character, the word being referred to as “the last matched word.” Each word following the “last matched word” is also known as a first predicated word.

If the character is not a terminating character, chatbot system 108 returns words starting with the characters entered. Note that the returned words might have no more than the two entered characters. User 102 continues to enter characters for processing as described above.

Where many candidates are matched, a limited number of candidate input messages can only be shown due to display device limitations. Thus, chatbot system 108 displays up to three candidate input messages to user 102. If three or less candidate input messages are matched, all of said candidate input messages are displayed to user 102.

If more than three candidate input messages are matched, chatbot system 108 determines whether there are more than three unique first predicated words. If here are more than three unique first predicated words, chatbot system 108 chooses three unique first predicated words from the candidates based on frequency of use. To identify the most frequently used words, a list of words sorted by their usage frequency can be stored. An N-gram data might also be utilized to select candidates for increased performance. In this manner, chatbot system 108 enhances user experience by displaying many different patterns with common utilized patterns being displayed first.

If there are three or less unique first predicated words, chatbot system 108 then determines whether there are more than three second predicated words. If there are more than three second predicated words, chatbot system 108 selects three unique second predicated based on frequency of use. To identify the most frequently used words, a list of words sorted by their usage frequency can be stored. An N-gram data might also be utilized to select candidates for increased performance. In this manner, chatbot system 108 enhances user experience by displaying many different patterns with common utilized patterns being displayed first.

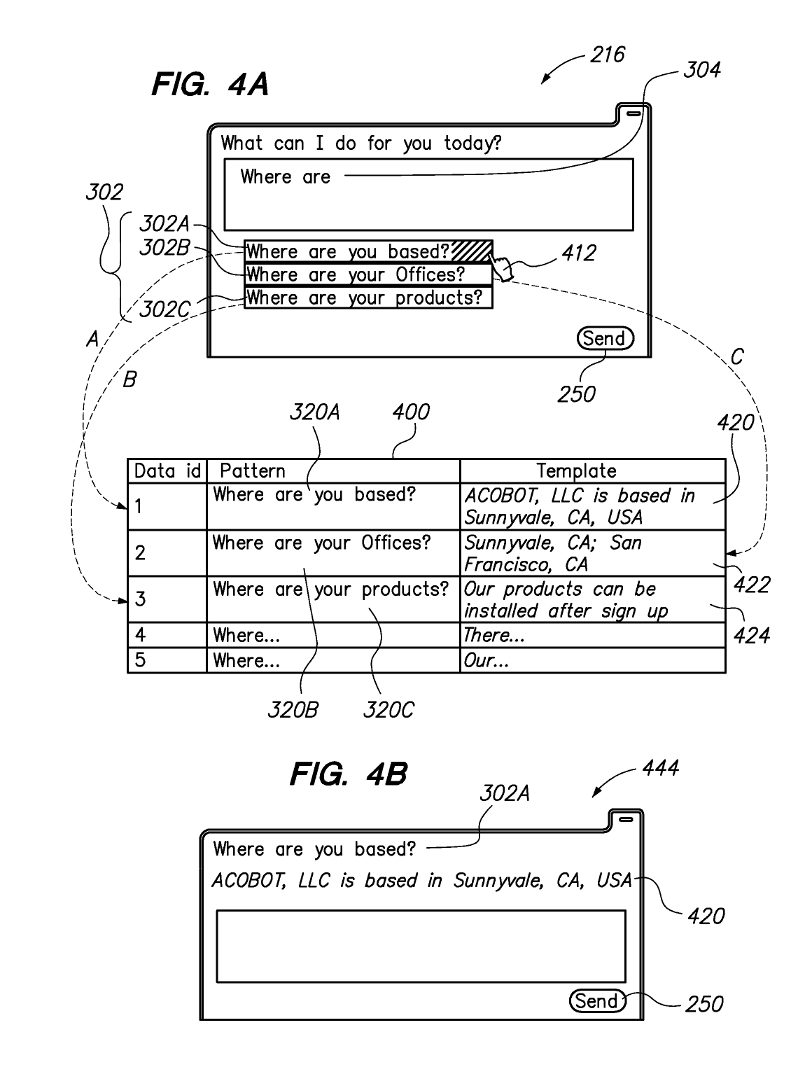

FIG. 4A illustrates chatbot dialog interface 216 of FIG. 2 and a corresponding knowledge table 400 according to an exemplary embodiment of the present invention.

In FIG. 4A, a user (e.g., user 102 of FIG. 1) has entered one or more characters “where are” 304 that begin to form an input message. In response, a plurality of candidate input messages 302 from which user 102 can select a complete input message is displayed. Specifically, candidate input message 302A, candidate input message 302B and candidate input message 302C are displayed as possible input messages based on one or more characters “where are” 304 entered by user 102

In one embodiment, an advantage of the present invention is that candidate input messages 302A, 302B and 302C are selected for display because they have corresponding responses or templates in knowledge table 400, and thus, selection of any of the candidate input messages is guaranteed to provide at least a quality response.

As shown in row one of table 400, candidate input message “Where are you based?” 302A is stored with its corresponding template output response “ACOBOT, LLC, is based in Sunnyvale, Calif., USA” 420. In row two, candidate input message “Where are your offices?” 302B is stored with its corresponding template output response “Sunnyvale, Calif.: San Francisco, Calif.” 422.

Further yet, in row three, candidate input message “Where are your products?” 302C is stored with its corresponding template output response “Our products can be installed after sign up” 424. In FIG. 4A, note that arrows A, B, and C are used to indicate that each of candidate input message “Where are you based?” 302A, candidate input message “Where are your offices?” 302B and candidate input message “Where are your products?” 302C, respectively, originate from knowledge table 400. Thus, in accordance with an embodiment of the present invention, when user 102 uses input device 412 to adopt any one of candidate input messages 302A, 302B or 302C, a match is based on knowledge table 400, and thus a quality response is guaranteed for display to user 102.

FIG. 4B illustrates chatbot dialog interface 444 according to an exemplary embodiment of the present invention.

In FIG. 4B, specifically, chatbot dialog interface 444 illustrates selection of candidate input message 302A as the input candidate and its corresponding output response 420 by chatbot system 108. Referring to FIG. 4A, user 102 has typed one or more characters “Where are” 304 and after reviewing the available candidate input messages has decided to select candidate input message “Where are you based?” 302A.

User 102 uses input device 412 (FIG. 4A) to hover over candidate input message “Where are you based?” 302A. Upon hovering, candidate input message 302A is highlighted (as shown by background shading 409)), and upon selection or submission via send button 250, candidate input message 302A is submitted to chatbot system 108 as an input message.

Upon receiving candidate input message “Where are you based?” 302A as input, chatbot system 108 responds by generating the corresponding template output response “ACOBOT, LLC is based in Sunnyvale, Calif. USA” 420 for viewing by the user.

Herein is another advantage of the present invention. Conventional systems may provide users with input candidates while they're typing, the purpose of which is typically to facilitate input of message. The input candidates are typically based on a dictionary-like list or previous user inputs. Although such conventional systems may improve reply quality because they assist users to reduce typos and to employ consistent words, they do not remarkably help chatbot systems to produce the right response because a match in the knowledge base is not guaranteed even when users adopt the candidates provided by such conventional systems.

Unlike conventional systems, an embodiment of the present invention is not simply based on dictionary-like lists or previous user inputs. An embodiment of the present invention provides candidate input messages that are based on input/output knowledge entry pairs and/or that are known to be capable of generating at least a quality response, thus, greatly improving the overall user experience.

Candidate generation: As noted above, an embodiment of the present invention further improves candidate generation as follows: where the patterns in the knowledge base contain any wildcards (* or /) to match one or more words in the input message, those patterns can either be excluded or the text before the first wildcard is kept.

Exclusions: If the knowledge base includes improper language patterns e.g. dirty words, chatbot system 108 excludes such patterns/knowledge entries from the candidate list by using a list of exclusion patterns such that when candidates are generated, the system excludes the knowledge entries that match any of the exclusion patterns.

If chatbot system 108 applies any transformation to the user input message, the reverse transformation can be applied to existing candidate input message to generate additional candidates. For example, assume that chatbot system transforms the United Kingdom spelling “colour” to United States spelling “color” in an input message, consequently, one of the candidate input messages is “What is your favorite color?” Chatbot system 108 can generate an additional candidate with UK spelling colour: “What is your favorite colour?” Chatbot system 108 also automatically updates the candidate list when the knowledge base is updated. In one embodiment, the source of each candidate is recorded. When the source (knowledge entry) is updated or deleted, the system updates or deletes the corresponding candidate.

Storing candidates in tree data structure: A further embodiment of the present invention uses a tree data structure to store candidates to increase efficiency of the searching process. The tree data structure includes a root node that is a virtual node from which the searching process begins. The children of the root node are the unique first words of the candidates (first level nodes). Children of the children of the root node are the unique second words following the first words (second level nodes), etc. Chatbot system 108 continues to add children of the children until all candidates are mapped to the tree data structure.

As user 102 types, chatbot system 108 matches the typed text against the above tree data structure. First, the system determines whether the first word of the typed text and any first level nodes are the same. If no, the system returns no candidate. If yes, the search process proceeds to the next level of nodes, etc. When all words in the typed text are matched, the system displays the candidates starting with these words as candidates.

Context: If chatbot system 108 is context enabled, the system adds the context information associated with the knowledge entries to the input candidates thus improving the overall user experience. Context can be but is not limited to the previous chatbot message. When the system searches for the candidates with context, the system first returns the patterns with context matched and then returns patterns without context if insufficient context matched patterns are obtained.

Sorting matched candidates: In a further embodiment, in order to improve user experience, chatbot system 108 sorts matched candidates based on reply quality or use frequency. Specifically, chatbot system 108 may display candidates with best quality replies and/or candidates most frequently used.

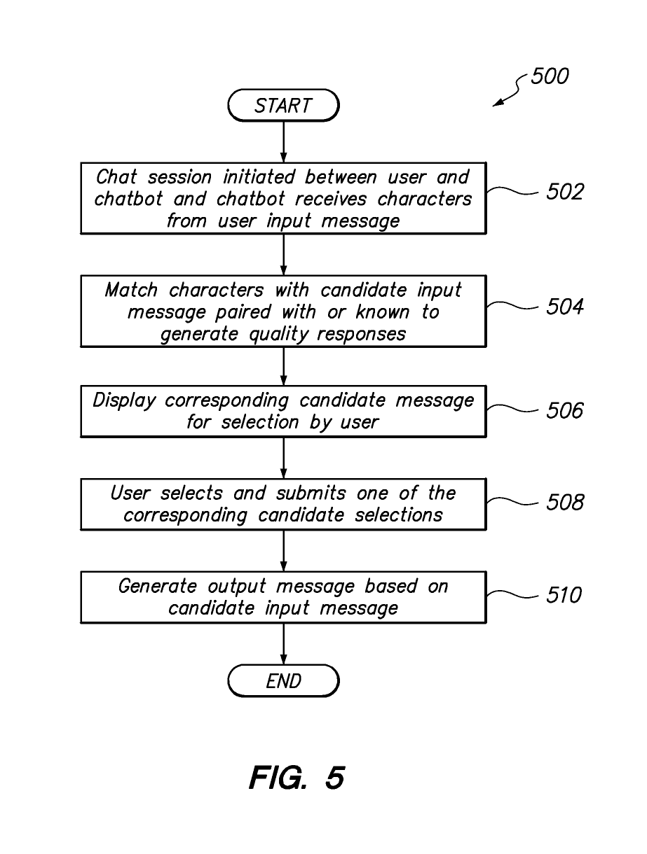

FIG. 5 illustrates candidate message chatbot method 500 in accordance with an embodiment of the present invention.

In FIG. 5, at block 502, chatbot method 500 involves initiating a chat session with chatbot system 108 when one or more characters 304 (FIG. 3) forming input message 210 (FIG. 2) are received from user 102 via chatbot dialog interface 216 (FIG. 2).

Here, user 102 can include, without limitation, a customer visiting a commercial website, a citizen visiting a government website, a participant in a social website. In some embodiments, chatbot system 108 includes a graphical image, including, without limitation, an avatar, a talking head, a text-to-speech engine and a text box.

Those skilled in the art will recognize that user 102 enters one or more characters 304 into chatbot dialog interface 216 to generate a plurality of candidate messages 302. As user 102 enters more characters 304, a plurality of candidate messages 302 may increase or conform more closely to user's 102 intended inquiries.

At block 504, chatbot method 500 matches one or more characters 304 of input message 210 with the plurality of candidate input messages 302 in knowledge database 150 that are known to have responses or can at least generate a quality response. A quality response is defined as one that is paired with a corresponding candidate input message in a knowledge base. In an alternate embodiment, a quality response might be one that is logical and/or makes sense—the type of response that is typically received during a natural language conversation between two human beings. Generating candidates based on the patterns without wildcards and/or the text before a first wildcard is typically sufficient to produce a quality response. In this manner, when user 102 adopts one of the plurality of candidate input messages 302, a match occurs in knowledge database 150, and thus a quality response displays for user 102.

In some embodiments, chatbot system 108 is operable to transform the spelling of input message 210 for matching with a plurality of candidate input messages 302. In yet another embodiment, chatbot system 108 is operable to transform the meaning of input message 210 for matching with a plurality of candidate input messages 302. For example, without limitation, if user 102 enters one or more characters 304 “What time do”, chatbot system 108 transforms the input to “What time do you open”, and “What time do you close”, to match and generate the appropriate plurality of candidate messages 302.

At block 506, chatbot method 500 then displays the plurality of candidate messages 302 (FIG. 3).

At block 508, user 102 selects from a plurality of candidate input messages 302 that are paired with quality responses or can generate a quality response. The candidate input messages 302 are grammatically correct, commonly utilized by different users 104, 106, and pertinent to the inquiry. In this manner, user 102 may minimize spelling or grammatical errors during typing while guaranteeing that a quality response is received.

In one embodiment of the present invention, user 102 selects from a plurality of candidate input messages 302 that best conform to user's 102 intended inquiry or statement. However, if a plurality of candidate messages 302 does not address user's 102 intended inquiry, user 102 may ignore the plurality of candidate messages 302 and enter a completed input message 210 to receive a pertinent output response 402. Chatbot system 108 is operable to automatically update knowledge database 150 (FIG. 1) after user 102 selects a plurality of candidate messages 302.

Those skilled in the art, in light of the present teachings, will recognize that a set of scripts or an independent software program utilizes computer code efficacious for building chatbot system 108, nesting, and parent/child relationships between objects and classes to write the computer code for processor 140, knowledge database 150, and chatbot system 108, including, without limitation, Artificial Intelligence, Java AIML, HTML, Markov chains and the like.

At block 510, chatbot method generates an output response corresponding to the candidate input message selected. For example, in FIG. 4B, user 102 has selected and submitted candidate input message 302A and responsive thereof, chatbot system 108 has generated and displayed output response 420 as shown.

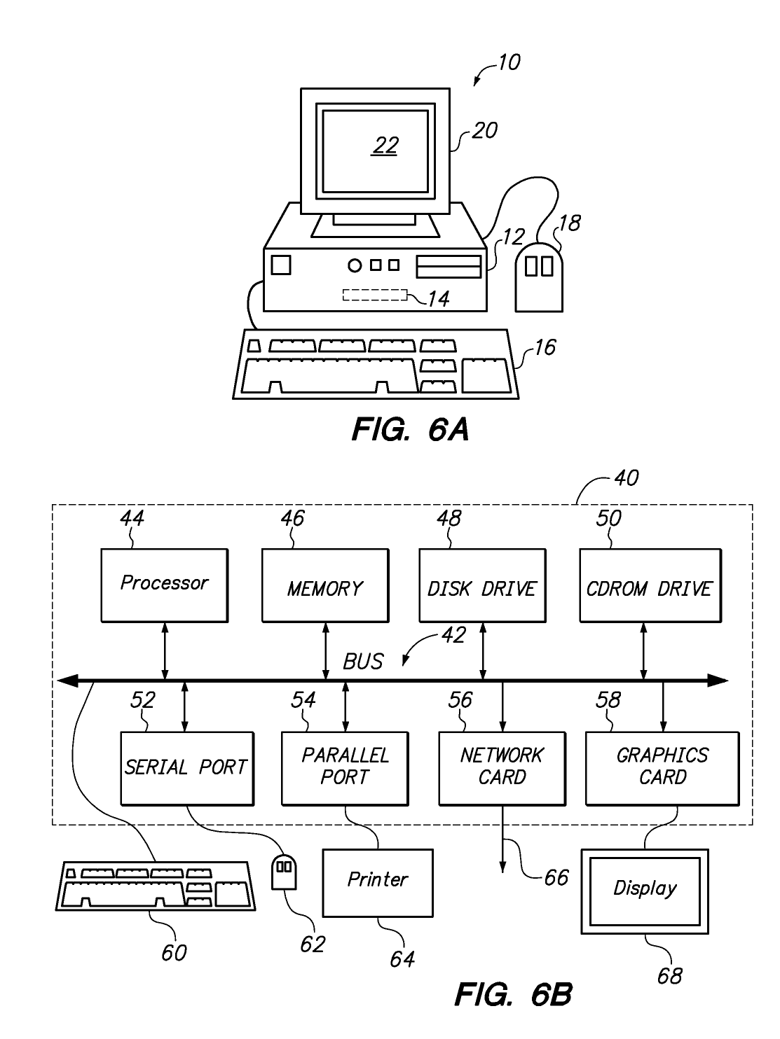

FIG. 6A illustrates a typical computer 10 such as would be operated by a user on the Internet.

In FIG. 6A, computer 10 includes a cabinet 12 housing familiar computer components such as a processor, memory, disk drive, Compact Digital Read-Only Memory (CDROM), etc. (not shown). User input devices include keyboard 16 and mouse 18. Output devices include display 20 having a display screen 22. Naturally, many other configurations of a computer system are possible. Some computer systems may other components in addition to those shown in FIG. 6A while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 6A. Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise the term “output device” includes all possible types of devices and ways to output information from a computer system to a human or to another machine.

The computer itself can be of varying types including laptop, notebook, palm-top, pen-top, etc. The computer may not resemble the computer of FIG. 6A as in the case where a processor is embedded into another device or appliance such as an automobile or a cellular telephone. Because of the ever-changing nature of computers and networks, the description of hardware in this specification is intended only by way of example for the purpose of illustrating the preferred embodiment. Any distributed networked system capable of executing programmed instructions is suitable for use with the present invention.

FIG. 6B illustrates subsystems of the computer of FIG. 6A.

In FIG. 6B, subsystems within box 40 are internal to, for example, the cabinet 12 of FIG. 6A. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system, and some of the subsystems shown in FIG. 6B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A method, operable by a chatbot, for selecting a user input message from a plurality of candidate input messages, wherein the chatbot includes a processor, an interactive dialog interface, and a knowledge database, the method comprising:
receiving at least one or more characters of an input message, said one or more characters being received during a chat session between a user and the chatbot;
matching the one or more characters of said input message with a plurality of candidate input messages such that no more than a selected ones of the plurality of candidate input messages having corresponding output responses in the knowledge database are matched while candidates without corresponding output responses in the knowledge database are not matched;
displaying the selected ones of the plurality of candidate input messages for selection by said user; and
upon selection of a user input message based on the selected ones of the plurality of candidate input messages, generating an output message corresponding to the selected user input message.

2. The method of claim 1 wherein matching the one or more characters further comprises
storing the plurality of candidate input messages in a tree data structure having at least a root node; and
searching the tree data structure for matching entries of a plurality of candidate input messages.

3. The method of claim 2 wherein said tree data structure includes a root node as well as children of the root node; and using said root node to begin searching for matching entries of a plurality of candidate input messages.

4. The method of claim 3 wherein children of said root node are unique first words of said plurality of candidate input messages, and children of children of said root node are unique second words of said plurality of candidate input messages.

5. The method of claim 2, wherein the tree data structure further comprises a first child node, wherein the first child node comprises at least one knowledge database character, wherein the chatbot queries the first child node for a candidate input message that matches at least a portion of said input message.

6. The method of claim 2 wherein the tree data structure further comprises at least one subsequent child node, wherein the at least one subsequent child node comprises the at least one knowledge database character, wherein the chatbot queries the at least one subsequent child node for at least one prior message that matches at least a portion of the input message after querying the first child node.

7. The method of claim 1, wherein the chatbot is operable to automatically update the knowledge database after the user selects the plurality of candidate messages.

8. The method of claim 1 further comprising transforming a spelling of the input message for matching with the plurality of candidate messages.

9. The method of claim 1 transforming a meaning of the input message for matching with the plurality of candidate messages.

10. A system, operable by a chatbot, for selecting a user input message from a plurality of candidate input messages, the system being operable to use an interactive display and a computer system capable of processing one or more lines of code, the system comprising:
one or more lines of code instructions receiving at least one or more characters of an input message, said one or more characters being received during a chat session between a user and the chatbot;
one or more lines of code instructions that match the one or more characters of said input message with a plurality of candidate input messages such that no more than a selected ones of the plurality of candidate input messages having corresponding output responses in the knowledge database are matched while candidates without corresponding output responses in the knowledge database are not matched;
one or more lines of code instructions that display the selected ones of the plurality of candidate input messages for selection by said user; and
one or more lines of code instructions, upon selection of a user input message based on the selected ones of the plurality of candidate input messages, generating an output message corresponding to the selected user input message.

11. The system of claim 10 wherein the one or more lines of code instructions that match the one or more characters further comprises
storing the plurality of candidate input messages in a tree data structure having at least a root node; and
searching the tree data structure for matching entries of a plurality of candidate input messages.

12. The system of claim 11 wherein said tree data structure includes a root node as well as children of the root node; said system further comprising one or more lines of code instructions that use said root node to begin searching for matching entries of a plurality of candidate input messages.

13. The system of claim 12 wherein children of said root node are unique first words of said plurality of candidate input messages; and children of children of said root node are unique second words of said plurality of candidate input messages.

14. The system of claim 11, wherein the tree data structure further comprises a first child node, wherein the first child node comprises at least one knowledge database character, wherein the chatbot queries the first child node for a candidate input message that matches at least a portion of said input message.

15. The system of claim 11 wherein the tree data structure further comprises at least one subsequent child node, wherein the at least one subsequent child node comprises the at least one knowledge database character, wherein the chatbot queries the at least one subsequent child node for at least one prior message that matches at least a portion of the input message after querying the first child node.

16. The system of claim 10, wherein the chatbot is operable to automatically update the knowledge database after the user selects the plurality of candidate messages.
